(19) United States
(12) Patent Application Publication
(10) Pub. No.: US 2019/0204795 A1
(43) Pub. Date: Jul. 4, 2019

(54) Communication System for Power Outlet Control Devices

(71) Applicant: Switcheroo LLC, Pittsburgh, PA (US)

(72) Inventors: Michael R. Neilson, Mckees Rocks, PA (US); David McGuire, New Kensington, PA (US)

(21) Appl. No.: 15/858,370

(22) Filed: Dec. 29, 2017

(51) Int. Cl. G05B 15/02; H04Q 9/14

(52) U.S. Cl. CPC G05B 15/02; H04Q 2209/40; H04Q 9/14

(57) ABSTRACT

A system selectively activates and deactivates delivery of power to a device by a power outlet using a pulsed sequence of on commands delivered at randomized intervals. The on commands may be sent by any number of sending devices. So long as a receiving device continues to receive on signals from any sending device on a selected channel, the receiving device will remain switched on and deliver power from the power outlet to a connected load. If the receiving device either (a) receives an off signal on the selected channel, or (b) stops receiving on signals on the selected channel for a timeout period, the receiving device will switch off and stop delivering power to the connected load.

### BACKGROUND

This patent document relates generally to methods and systems for controlling delivery of power and in particular to controlling delivery of power by a power outlet.

In electrical systems in residential and commercial buildings, limitations exist where a wall switch is wired to control only a fixed lighting fixture or power outlet, or multiple switches (e.g., two-way, three-way) are wired to control a single lighting fixture or device. Once the electrical wiring is done for the building, the switch cannot be changed to control another lighting device or outlet, and no additional outlets or lighting can be added to the control. In real applications, a user's needs for power control may change from time to time. For example, the user has re-arranged the furniture inside a home and may want to move a single lamp to a different area of the house and wish that the lamp can be controlled by a different switch in the house. The user may also have a need to add extra lamps to a wall switch in the house. The user may also want to use an existing wall switch to control a timer or holiday lightings on a temporary basis. The wiring system in an existing home or building would not be able to achieve these without remodeling of the home or use of extension cords.

Home automation technologies, such as X10, offer some flexibilities in the control of home appliances using the home power line. However, X10 technologies require a user to replace an existing wall switch with an X10 switch to be installed into the outlet. Such modification of the wall switch may require someone skilled in handling electrical wiring inside the home. Further, X10 transmits signals over the power line, which may not always be reliable. Modern smart home technologies offer home automation that allows a user to program and control various devices at home. However, this solution has drawbacks in terms of the complexity and cost of the system. Such a solution also often uses Wi-Fi, which requires installation and configuration (e.g., using a secure password) of Wi-Fi. Such a solution also may use applications on a user's mobile electronic device, requiring installation of an application on the user's mobile device and also requiring the user to carry the mobile device in order to control a light. All of these can be cumbersome to the user.

### SUMMARY

A communication system for activating and deactivating the delivery of power to a power outlet includes a transmitting device that has a power port configured to couple with a first power source controllable by a switch, a transmitter configured to transmit on and off commands on a communication link, and a circuit. The circuit is configured to cause the transmitter to transmit the on and off commands on the communication link when the power port is coupled with the first power source and the first power source is switched to on and off, respectively. In some scenarios, when the transmitting device is coupled with the first power source, and the first power source is switched from off to on, the transmitting device transmits a sequence of on commands at randomized time intervals.

The system also includes a receiving device that has a power port configured to couple with a second power source, a receiver configured to receive commands on the communication link, a controlled port for receiving a power load, and a circuit. The circuit of the receiving device is configured to cause the receiver to receive the on and off commands from the transmitting device on the communication link and, in response to receiving the on and off commands, activate and deactivate the delivery of power from the second power source to the controlled port, respectively.

In some scenarios, the transmitting device may further include an energy storage element, such as a battery or a capacitor. The capacitor is configured to store power when the device is coupled with the power source and the power source is on. When the power source is off, the capacitor may provide the stored power to the transmitting device to allow the device to transmit commands on the communication link before the device is completely powered off.

In some or other scenarios, the circuit of the receiving device is configured to, in response to the receiver receiving an off command on the communication link, deactivate the delivery of power from the second power source to the controlled port. In some or other scenarios, the circuit of the receiving device is configured to, in response to the receiver receiving an on command on the communication link, activate the delivery of power from the second power source to the controlled port. In some or other scenarios, the circuit of the transmitting device is configured to, when the power port of the transmitting device is coupled with the first power source and the first power source is switched from off to on, transmit a sequence of on commands. The circuit of the receiving device may also be configured to deactivate the delivery of power from the second power source to the controlled port at an end of a time-off period only if the receiver has not received any on command on the communication link within the time-off period.

Each of the transmitting and receiving devices may also include a channel selection switch so that both devices may be set to one of the multiple channels. A transmitting device that is set to a particular channel may transmit commands over the communication link for one or more receivers that are also set to the same channel to receive the transmitted commands. Each of the plurality of channels may be represented by a unique digital channel identification code. Each of the commands may include a header followed by a command code, where the header includes the unique digital channel identification code representing one of the multiple channels.

### BRIEF DESCRIPTION OF THE DRAWINGS

FIG. 1 illustrates a diagram of an example of a communication system for activating and deactivating the power to a power outlet.

FIG. 2 illustrates a diagram of an example of transmitting or receiving device in the system of FIG. 1.

FIG. 3 illustrates various scenarios in which the delivery of power to a power outlet is activated or deactivated.

FIG. 4 illustrates an example of a command transmitted or received on a communication link in the system in FIG. 1.

### DETAILED DESCRIPTION

In this document, the singular forms “a,” “an,” and “the” include plural references unless the context clearly dictates otherwise. The term “comprising” means “including, but not limited to.” Similarly, the term “comprises” means “includes, and is not limited to.” Unless defined otherwise, all technical and scientific terms used in this document have the same meanings as commonly understood by one of ordinary skill in the art.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The term “couple,” when used with reference to a power source refers to either a physical connection to the power source, e.g., via a connection port, or a wireless connection to the power source, e.g., via induction, so that power can be withdrawn from the power source. The connection may be a direct connection or an indirect connection via one or more conductors.

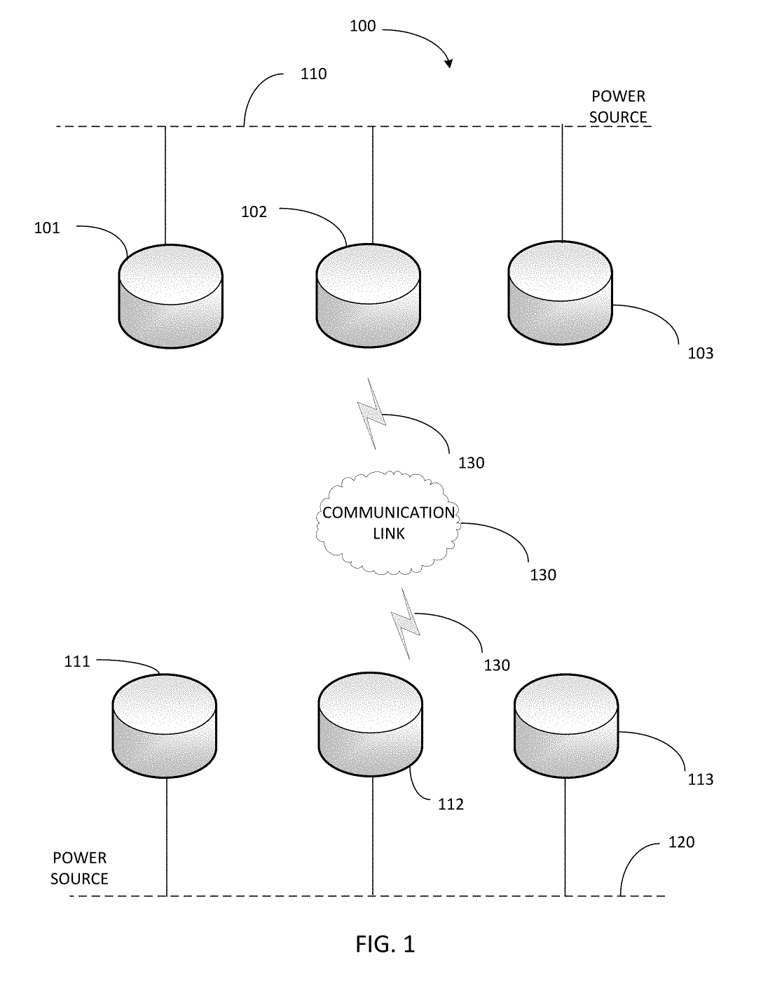

In FIG. 1, in some scenarios, a communication system includes one or more transmitting devices, e.g., 101, 102, 103, a communication link 130 and one or more receiving devices, e.g., 111, 112, 113. Each of the transmitting devices 101, 102, 103 is coupled with a first power source 110 and configured to detect if the first power source 110 is turned on or off, and correspondingly transmit commands over the communication link 130 to control other devices. Each of the receiving devices 111, 112, 113 is coupled with a second power source 120 and configured to receive commands over the communication link 130. The receiving devices 111, 112, 113 each has a controlled port for receiving a power load, such as an appliance, and is configured to activate or deactivate delivery of power from the second power source 120 to the controlled port based on the received commands.

In some scenarios, when the first power source 110 is turned from off to on, the transmitting device 101, 102, 103 may transmit one or more on commands to the receiving device 111, 112, 113 to activate delivery of power from the second power source 120 to the controlled port 222 of each receiving device. In other scenarios, when the first power source 110 is turned from on to off, the transmitting device 101, 102, 103 may transmit one or more off commands to the receiving device 111, 112, 113 to deactivate the delivery of power from the second power source 120 to the controlled port 222 of each receiving device.

In some or other scenarios, the communication link 130 can be a wireless link, such as a radio frequency band, e.g., a 900 MHz industrial, scientific, and medical (ISM) band. Other communication links, existing or later developed, may also be used. The first power source 110 and the second power source 120 may be different power lines. For example, the first power source 110 may be a power line in a first building, whereas the second power source 120 may be a different power line in a second building. Alternatively, the first power source 110 and the second power source 120 may also be the same power source, e.g., on the home power line provided by the electrical panel of the house or other building.

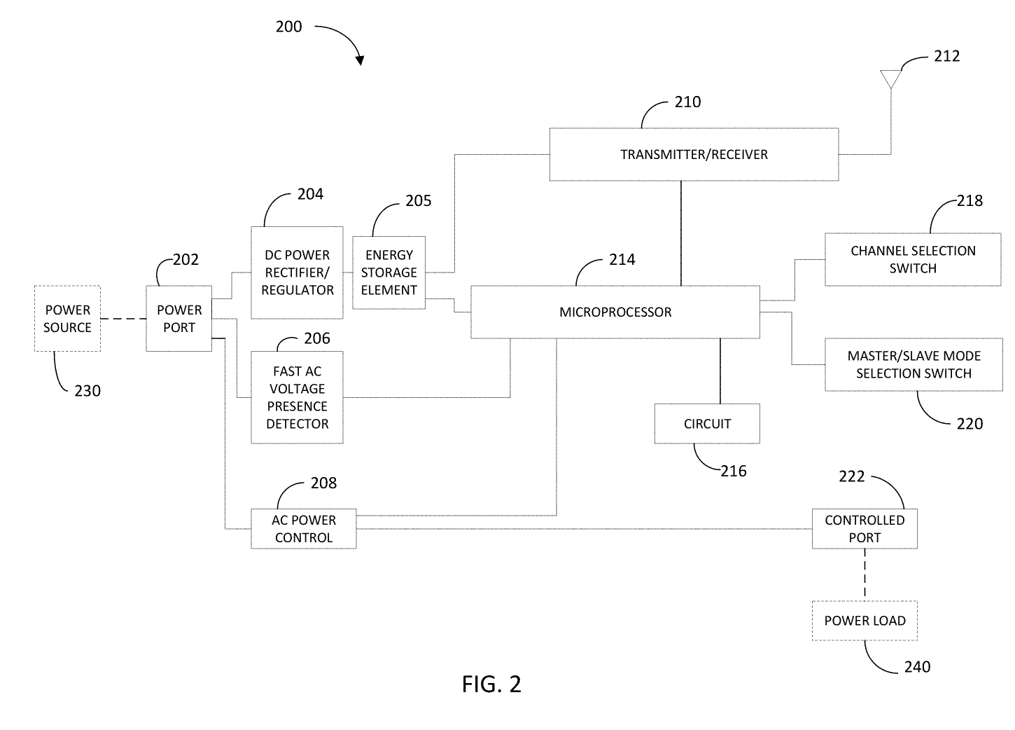

In FIG. 2, a transmitting device or a receiving device 200 is described in more detail. A transmitting or receiving device 200 may include a power port 202 configured to couple with a power source 230. In some scenarios, the power source 230 may be a fixed power outlet, such as a wall outlet, in a residential or commercial building. The power port 202 may be a power plug positioned to plug into the power source. For example, to couple with a fixed power outlet, the power port 202 may be a standard two-prong or three-prong power plug that can be physically plugged into the power outlet, such as a wall outlet. In other scenarios, the power source 230 may also be a portable power outlet, such as a power outlet from a generator or a movable power station. The power port 202 may be any suitable power plug or connection for coupling to the power source 230. In some or other scenarios, the power port 202 may also be coupled with the power source 230 inductively without any physical connection.

The device 200 also includes a processing device, such as a circuit 216 having a microprocessor 214 and other components, and configured to perform various functions of the device. For example, the circuit 216 may include a printed circuit board (PCB) and have the microprocessor 214 mounted thereon. The device 200 also includes an antenna 212 and a transmitter or receiver 210 configured to transmit or receive a control command over the communication link via the antenna 212. For example, a transmitting device may be configured to transmit a control command, and a receiving device may be configured to receive the control command. In some or other scenarios, the device 200 may have both a transmitter and a receiver, or a combined transceiver in an integrated circuit (IC). In such a case, the device 200 can function as both a transmitter and a receiver. Additionally, the device 200 may also include a master/slave mode selection switch 220 that is configured to set the microprocessor 214 to operate as transmitting device (master mode) or receiving device (slave mode).

The device 200 may further include a direct current (DC) power rectifier or regulator 204 configured to provide a regulated voltage, e.g., a low DC voltage for powering the microprocessor 214 and the circuit 216. The DC power rectifier or regulator 204 may also be configured to provide power for the transmitter or receiver 210. The device 200 may also include a fast AC voltage presence detector 206 configured to detect whether there is power at the power port 202. For example, the power source 230 is a fixed outlet that is controlled by a switch. When the switch is turned off, the power from the power source 230 to the power port 202 is cut off, and the AC voltage presence detector 206 may detect that the power port 202 has no power.

The device 200 may further include a controlled port 222 that is configured to receive a power load 240, such as an appliance. The circuit 216 may also include an AC power control 208. When the device 200 functions as a receiving device, the AC power control 208 may be configured to activate or deactivate the delivery of power from the power source 230 to the controlled port 222 based on a control command received from the receiver 210. The AC power control 208 may be a relay or a solid state TRIAC (TRIode for Alternating Current). The relay may be an electromechanical relay. The relay may also be a solid state relay. In some scenarios, an on or off command received at the receiving device may cause the receiving device to generate a blip from the AC power control 208.

The device 200 may also include a channel selection switch 218. In some scenarios, the device 200 may be capable of handling a fixed number of channels, e.g., 8 or 16. In order for a transmitting device to control a receiving device, both the transmitting and receiving devices must be using the same channel. This can be done by selecting the channel selection switch 218 for both the transmitting and receiving devices to set to the same channel. The selection of the channel selection switch 218 corresponds to one of the multiple channels that can be set by the channel selection switch, each of the channels is represented by a unique digital channel identification code.

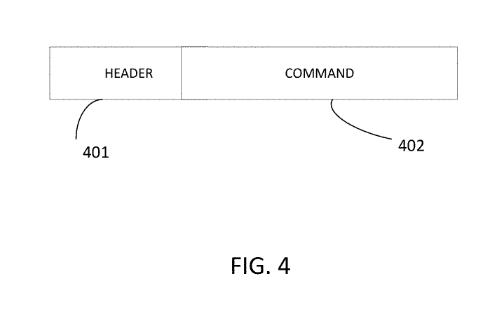

In FIG. 4, each control command may include a header 401 followed by a command code 402. The header 401 may be of a fixed length and may include a unique digital channel identification code. For example, the header may have a length of 4-bit, 6-bit or 8-bit. A header of 4 bits may accommodate up to 16 channels; a header of 6 bits may accommodate up to 64 channels; and a header of 8 bits may accommodate up to 256 channels. The command code 402 may also be of a fixed length, such as 4 bits, 6 bits, 8 bits, 16 bits, or other bit length to accommodate various combinations of commands. A device that is capable of transmitting or receiving on and off commands may only need a 1-bit command code.

In some scenarios, the channel selector 218 of the transmitting device and the receiving device may be configured to cause each device to use the same digital channel identification code to respectively transmit and receive the on and off commands. For example, a transmitter for which channel selector 218 is set to channel 1 is configured to only transmit a command that includes a header corresponding to channel 1. Similarly, a receiver for which channel selector 218 is set to channel 1 is configured to receive a command that includes the header corresponding to channel 1.

With the channel selection, the system (as shown in FIG. 1) can have various configurations. For example, one transmitting device may be configured to control one or more receiving devices on one channel, and another transmitting device may be configured to control one or more receiving devices on another channel. There can also be more than one transmitting device to control the same receiving devices.

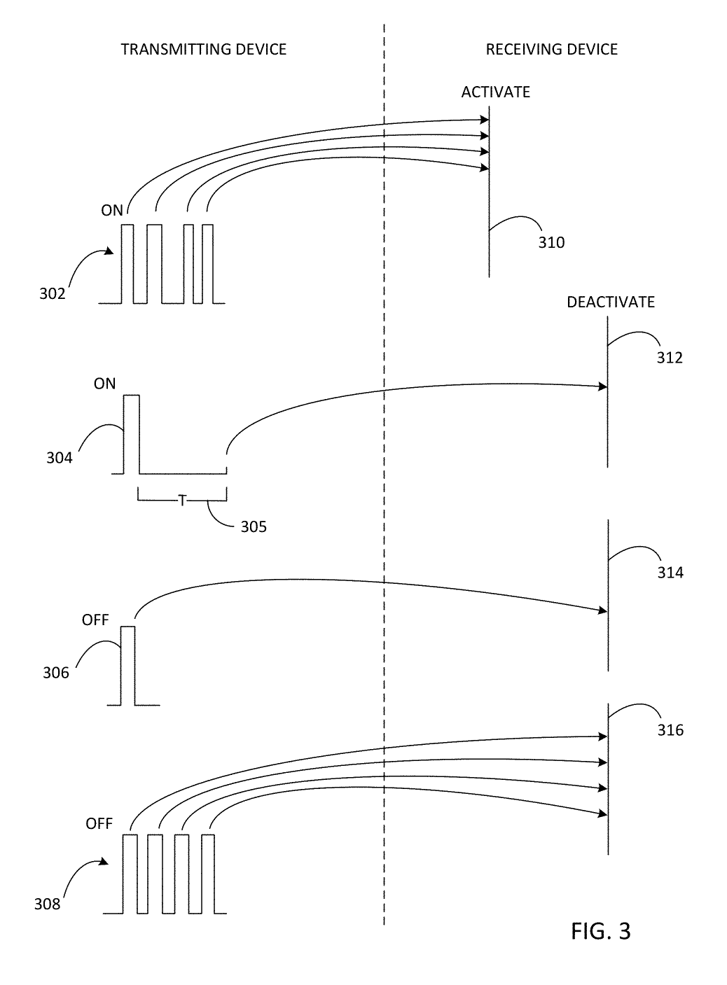

In some scenarios, the control commands transmitted or received by the transmitting or receiving device may include two types: an on command and an off command. With reference to FIGS. 2 and 3, in a non-limiting example, when the device 200 functions as a transmitting device, the microprocessor 214 may be configured to transmit on or off commands based on the condition of the power port 202 that is coupled with the power source 230. In some scenarios, when the switch that controls the power source 230 is switched from off to on, the fast AC voltage presence detector 206 detects the power at the power port 202, and the microprocessor 214 may be configured to transmit a pulsed sequence of on commands 302. The sequence of on commands 302 may include multiple on commands at randomized time intervals. In a receiving device (with the same structure as described in FIG. 2), the receiver 210 receives the sequence of on commands. In response to receiving each of the on commands, the receiving device may be configured to activate 310 the delivery of power from the power source to the controlled port.

The use of randomized time intervals helps to avoid collision in which more than one transmitting device are transmitting control commands on the same channel at the same time. Sending the sequence of on commands at randomized time intervals may help avoid such collisions and allow the receiving device to receive all controlling commands from any transmitting device on the same channel. In some scenarios, the randomized time interval is in the range from 4 to 11 milliseconds.

With continued reference to FIG. 3, alternatively, and/or additionally, when the switch that controls the power source 230 is switched from off to on, the transmitting device may be configured to continuously (e.g., constantly or intermittently) transmit on commands 304. The receiving device is configured to detect one or more on commands. If during a time-off period T 305, the receiving device has not received any on command, the receiving device may deactivate 312 the delivery of power from the power source to the controlled port. The time-off period will allow the device to overcome signal interference caused by the noise in the channel. For example, in the event that interference has prevented an off command from being received when a transmitting device on the same channel is powered off, the implementation of the time-off period will allow the receiving device to still be able to deactivate the delivery of power to the controlled port because no on commands have been received in the time-off period. In some scenarios, the time-off period is in the range from 100 to 5000 milliseconds.

In some or other scenarios, in response to receiving an off command 306 on the communication link, the receiving device may be configured to deactivate 314 the delivery of power from the second power source to the controlled port.

With reference to FIG. 2, in some or other scenarios, the transmitting device may further include an energy storage element 205 configured to provide a stored power. When the power source with which the transmitting device is coupled is switched off, the stored power will allow the transmitting device to continue operating and be able to transmit one or more off commands on the communication link. This allows the transmitting device to be able to transmit the commands that can be received by the receiving device in time before the transmitting device is completely powered off. Examples of the energy storage element include a battery and a capacitor. The capacitor may be configured to store the stored power when the transmitting device is coupled with the power source and the power source is switched on.

Returning to FIG. 3, in response to detecting that the power source is switched off, a transmitting device may be configured to transmit a sequence of off commands 308 at a time interval on the communication link. The time interval may be short enough so that the transmitting device is able to transmit a sufficient number of off commands within an expected time period in which the stored power in the capacitor will be depleted.

A system may implement the above on and off commands in various ways to suit different applications. In some scenarios, the system may be configured to allow more than one transmitting device on the same channel to control one or more receiving devices on that channel. For example, when there are multiple transmitting devices, each transmitting device is configured to transmit a sequence of on commands 304 when the power source is switched on. The receiving device may be configured to detect one or more commands and deactivate 312 delivery of power from the power source to the controlled port if, during a time-off period T 305, the receiving device has not received any on command. In such scenario, if two transmitting devices are both on the same channel and the power for only one device is turned off, the receiving device will remain uninterrupted until both transmitting devices are turned off.

Returning to FIG. 2, the illustrated device may be made as a transmitting and receiving device and include the master/slave mode selection switch 220 that can be set to switch the device to transmitting or receiving mode. In some or other scenarios, each device may be made a transmitting only or receiving only device. For example, a transmitting device may include: a power port configured to couple with a power source controllable by a switch; a transmitter configured to transmit on and off commands on a communication link; and a circuit configured to cause the transmitter to transmit the on and off commands on the communication link when the power port is coupled with the power source and the power source is switched to on and off, respectively. The circuit is further configured to, when the power port is coupled with the power source and the power source is switched from off to on, transmit a sequence of on commands at randomized time intervals.

In some or other scenarios, a receiving device includes: a power port configured to couple with a power source; a receiver configured to receive on and off commands from a device on a communication link; a controlled port for receiving a power load; and a circuit configured to cause the receiver to receive the on and off commands on the communication link and, in response to receiving the on and off commands, activate and deactivate the delivery of power from the power source to the controlled port, respectively. The on commands are transmitted as a sequence of on commands at randomized time intervals.

The above illustrated embodiments provide advantages over existing home or commercial power control systems. For example, the transmitting and receiving devices can be made of the same configuration, with a master/slave mode selection switch to switch the transmitting/receiving mode of the device. Each transmitting device may continuously broadcast a sequence of on or off commands on a channel without knowing how many receivers are on the communication link. Any number of receivers, once selected to the same channel as the transmitting device, may receive the control commands from the transmitting device Similarly, any number of transmitting devices can be selected to the same channel and control one or more receiving devices on that channel. With randomized time intervals used for transmitting a sequence of on commands, collisions between multiple transmitting devices can be avoided. Thus, the system can be made scalable in real deployment. Other advantages include the use of a time-off period in deactivating the delivery of power to a controlled port to prevent interference from noise in the communication link. Advantages also include the use of energy storage element that enables the transmitting device to transmit a sufficient number of off commands that can be received by the receiving device before the transmitting device is completely powered off.

The features and functions described above, as well as alternatives, may be combined into many other different systems or applications. Various alternatives, modifications, variations or improvements may be made by those skilled in the art, each of which is also intended to be encompassed by the disclosed embodiments.

1. A system for activating and deactivating a power outlet, comprising:
a first device comprising:
a power port configured to couple with a first power source controllable by a switch,
a transmitter configured to transmit on and off commands on a communication link, and
a circuit configured to cause the transmitter to transmit the on and off commands on the communication link when the power port is coupled with the first power source and the first power source is switched to on and off, respectively; and
a second device comprising:
a power port configured to couple with a second power source, a receiver configured to receive the on and off commands on the communication link,
a controlled port for receiving a power load, and
a circuit configured to cause the receiver to receive the on and off commands from the first device on the communication link and, in response to receiving the on and off commands, activate and deactivate delivery of power from the second power source to the controlled port, respectively;
wherein the first device is configured to, when coupled with the first power source and in response to the first power source being switched from off to on, transmit a sequence of on commands to the second device on the communication link at randomized time intervals.

2. The system of claim 1, wherein the circuit of the second device is configured to, in response to the receiver receiving an on command on the communication link, activate the delivery of power from the second power source to the controlled port.

3. The system of claim 1, wherein the circuit of the second device is configured to, in response to the receiver receiving an off command on the communication link, deactivate the delivery of power from the second power source to the controlled port.

4. The system of claim 1, wherein the randomized time intervals are in a range from 4 to 11 milliseconds.

5. The system of claim 1, wherein:
the circuit of the first device is configured to, when the power port of the first device is coupled with the first power source and in response to the first power source being switched from off to on, transmit the sequence of on commands; and
the circuit of the second device is configured to deactivate the delivery of power from the second power source to the controlled port at an end of a time-off period only if the receiver has not received any on command on the communication link within the time-off period.

6. The system of claim 5, wherein the time-off period is in a range from 100 to 5000 milliseconds.

7. The system of claim 1, wherein the first device further comprises an energy storage element configured to provide stored power to allow the first device to transmit an off command on the communication link when the first power source is switched off.

8. The system of claim 7, wherein the energy storage element is a capacitor or battery configured to store the stored power when the first device is coupled with the first power source and the first power source is switched on.

9. The system of claim 8, wherein the circuit of the first device is configured to:
detect that the first power source is switched off; and
in response to detecting that the first power source is switched off, transmit a sequence of off commands at a time interval on the communication link.

10. The system of claim 1, wherein the first power source and the second power source are each fixed power outlets.

11. The system of claim 10, wherein the power port of the first device is a power plug positioned to plug into the first power source.

12. The system of claim 10, wherein the power port of the second device is a power plug positioned to plug into the second power source.

13. The system of claim 10, wherein the controlled port of the second device is a power outlet.

14. The system of claim 1, wherein the communication link is a 900 MHz radio frequency band.

15. The system of claim 1, wherein:
the first device comprises a channel selector configured to switch the transmitter to a plurality of channels;
the second device comprises a channel selector configured to switch the receiver to a plurality of channels; and
the second device is configured to receive the on and off commands from the first device when the channel selectors are each set to the same channel.

16. The system of claim 15, wherein:
each of the plurality of channels is represented by a unique digital channel identification code;
each of the on and off commands includes the unique digital channel identification code representing one of the plurality of channels; and
the channel selector of the first device and the channel selector of the second device are configured to cause the transmitter of the first device and the receiver of the second device to use a same digital channel identification code to respectively transmit and receive the on and off commands;
wherein the on and off commands each include the same digital channel identification code followed by a control command.

17. The system of claim 1, wherein the second device comprises a relay or Triode for Alternating Current (TRIAC) for alternating current configured to activate and deactivate the delivery of power from the second power source to the controlled port by the received on and off command.

18. The system of claim 1 further comprising one or more additional devices, wherein each additional device comprises:
a power port configured to couple with an additional power source;
a receiver configured to receive the on and off commands on the communication link;
a controlled port for receiving a power load; and
a circuit configured to cause the receiver of the additional device to receive the on and off commands from the first device on the communication link and, in response to receiving the on and off commands, activate and deactivate delivery of power from the additional power source to the controlled port of the additional device, respectively.

19. A device for activating and deactivating a power outlet, comprising:
a power port configured to couple with a power source controllable by a switch;
a transmitter configured to transmit on and off commands on a communication link;
a channel selector configured to switch the transmitter to one of a plurality of channels; and
a circuit configured to cause the transmitter to transmit the on and off commands on a selected one of the channels via the communication link when the power port is coupled with the power source and the power source is switched to on and off, respectively;
wherein the circuit is configured to, when the power port is coupled with the power source and in response to the power source being switched from off to on, transmit a sequence of on commands on the communication link at randomized time intervals.

20. (canceled)
